(19) United States
(12) Patent Application Publication
(10) Pub. No.: US 2010/0091365 A1
(43) Pub. Date: Apr. 15, 2010

(54) Screen

(75) Inventors: Tzeng-Ke Shiau, Hsinchu (TW); Chih-Jen Tsang, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/585,907

(22) Filed: Sep. 29, 2009

(30) Foreign Application Priority Data
Oct. 15, 2008 (TW) 097139619

(51) Int. Cl. G03B 21/56

(52) U.S. Cl. 359/448

(57) ABSTRACT

A screen adapted to a projection device having a transparent layer, a plurality of light-mixing chambers, and a plurality of lens structures is provided. The light-mixing chambers are located on a back surface of the transparent layer away from the projection device. The lens structures are disposed on a front surface of the transparent layer facing towards the projection device and corresponding to the light-mixing chambers respectively. The size of the opening of the light-mixing chamber is smaller than the size of the bottom surface of the corresponding lens structures. The lens structure is adapted to refract a light beam from the projection device, and the opening of the corresponding light-mixing chamber is adapt to allow the light beam pass through, such that the corresponding light-mixing chamber is adapted to concentrate the light beam therein and transform the light beam into a light beam projected out of the screen.

### BACKGROUND OF THE INVENTION

(1) Field of the Invention

The present invention relates to a screen, and more particularly relates to a screen adapted to a projection device.

(2) Description of the Related Art

FIG. 1 is a schematic view of a screen 100 of a typical projection device. As it shows, the screen 100 has a substrate 120, a transparent layer 140, a plurality of light absorbing structures 160 with a sharp angle, and a plurality of light diffusion layers 180. The light absorbing structures 160 disposed on the surface of the substrate 120 facing towards an image source 200 with a certain interval between each other divide the substrate 120 into a plurality of areas A. The light diffusion layer 180 is disposed on the bottom of each of the areas A for randomly reflecting the image lights R1, R2 from the image source 200 to enlarge the viewing angle of the screen 100. The transparent layer 140 covers a plurality of the light absorbing structures 160 and a plurality of the light diffusion layers 180 for protection.

The light absorbing structure 160 with a sharp angle is made of light-diffusing particles or light absorbing material. The index of refraction of the light absorbing structure 160 is smaller than the index of refraction of the transparent layer 140. Thus, the light beam projected to the light absorbing structure 160 from the transparent layer 140 may be totally reflected at the interface between the transparent layer 140 and the light absorbing structure 160. In detail, when the image light beam R1 from the image source 200 (such as a projector) penetrates the transparent layer 140 and reaches the interface between the transparent layer 140 and the light absorbing structure 160 with an incident angle larger than the critical angle of a total reflection, the image light beam R1 would be totally reflected at the interface between the transparent layer 140 and the light absorbing structure 160, and scattered by the light diffusion layer 180 for providing image with wide viewing angle.

On the other hand, as the environment light beam R3 with large incident angle (such as the inclined incident light beam from the fluorescent lamp) projected to the interface between the transparent layer 140 and the light absorbing structure 160 through the transparent layer 140, the incident angle of the environment light beam R3 with respect to the light absorbing structure is smaller than the critical angle of total reflection at the interface between the transparent layer 140 and the light absorbing structure 160. Thus, the environment light beam R3 would be refracted into the light absorbing structure 160 and absorbed by the light absorbing structure 160. Thereby, the screen 100 may decrease the glare light caused by the environment light sources such as the fluorescent lamp.

Though the screen 100 in FIG. 1 is capable to fulfill the object of wide viewing angle and glare reduction, the distribution of viewing area is not symmetrically distributed relative to the center of the screen 100. Furthermore, for general usage, the projector (the image source 200) is not disposed right behind the center of the screen 100 and deviated from a central line of the screen 100, so that audience may enjoy images right in front of the screen 100. As FIG. 1 shows, the image source 200 is disposed under the central line of the screen 100 and upwardly projects image to the screen 100. Noticeably, among the light beam from the image source 200, light-absorbed rate of the inclined image light beam R2 by the light absorbing structure 160 is larger than light-absorbed rate of the vertical image light beam R1, which means that the screen 100 has a worse reflectivity for the inclined image light beam R2 than reflectivity for the vertical image light beam R1. Compared to the lower observation position, a large part of the image light beam accepted at the higher observation position comes from the upwardly inclined image light beam from the image source 200, which results in a lower image brightness and contrast at the higher observation position and further impacts the image uniformity of the screen 100.

### SUMMARY OF THE INVENTION

The present invention provides a screen adapted to a projection device, which is able to improve the symmetry of images from the screen and enhance the uniformity of images at different observation position so as to enlarge the viewing angle of the screen.

The present invention also provides a screen adapted to a projection device to reduce glare light.

Other advantages and objects of the present invention may be further comprehended through the technical features disclosed in the present invention.

In order to achieve one or part of or all the objectives or other objectives, a screen adapted to a projection device is provided in an embodiment of the present invention. The screen has a transparent layer, a plurality of light-mixing chambers, and a plurality of lens structures. The light-mixing chambers are disposed on a back surface of the transparent layer away from the projection device. The lens structures are disposed on a front surface of the transparent layer facing towards the projection device and corresponded to the light-mixing chambers respectively. The size of an opening of each of the light-mixing chambers is smaller than the size of a bottom surface of each of the corresponding lens structures connecting the front surface of the transparent layer. Each of the lens structures is adapted to refract a light beam from the projection device, and the opening of each of the corresponding light-mixing chambers is adapted to allow the light beam pass through, such that each of the corresponding light-mixing chambers is adapted to concentrate the light beam therein and transform the light beam into a light beam projected out of the screen.

The viewing area of the screen shown in FIG. 1 is not symmetrically distributed relative to the center of the screen, which influences the uniformity of image contrast at different observation positions. In contrast, the screen provided in the embodiment of the present invention has a light-mixing chamber on the back surface of the transparent layer away from the projection device and a lens structure on a side surface of the transparent layer facing towards the projection device. With the help of the lens structure, the inclined light beams from the projection device are concentrated in the light-mixing chamber and transformed into out-projection illumination, which is symmetrically distributed with respect to the central line of the opening of the light-mixing chamber. Thus, the consistent of images at different observation positions is improved and the viewing angle of the screen is enlarged.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which:

FIG. 1 is a schematic view of a typical screen of a projection device;

FIG. 2 is a cross-sectional view showing an embodiment of a screen of a projection device according to the present invention;

FIG. 3A to FIG. 3D are cross-sectional views of four different embodiments of the light-mixing chamber according to the present invention;

FIG. 4A and FIG. 4B are schematic views showing two different embodiments of the configuration of the light-mixing chamber on the screen according to the present invention; and

FIG. 5 is a schematic view showing another embodiment of the screen of the projection device according to the present invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

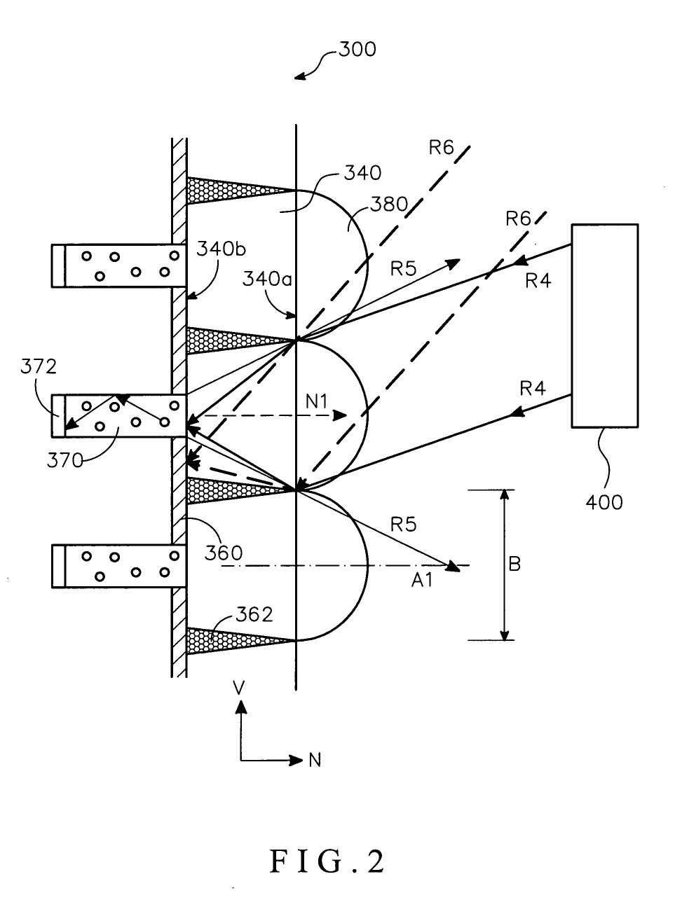

FIG. 2 is a cross-sectional view showing an embodiment of a screen 300 of a projection device according to the present invention along a vertical direction V and a normal direction of the screen 300, and the projection device 400 is disposed in front of the screen 300. As it shows, the screen 300 has a transparent layer 340, a plurality of light-mixing chambers 370, and a plurality of lens structures 380. The light-mixing chambers 370 are located on a back surface 340b of the transparent layer 340 away from the projection device 400. The lens structures 380 are located on a front surface 340a of the transparent layer 340 facing towards the projection device 400 and corresponding to the light-mixing chambers 370 respectively. Specifically, the focuses of the lens structures 380 are substantially located in the light-mixing chambers 370 respectively. The size of each of the openings of the light-mixing chambers 370 is smaller than the size of the bottom of each of the corresponding lens structures 380 connecting the front surface 340a of the transparent layer 340.

The screen 300 further has a light absorbing layer 360, which covers the back surface 340b of the transparent layer 340 and surrounds the openings of the light-mixing chambers 370. Moreover, a plurality of light absorbing walls 362 are disposed on the light absorbing layer 360. The light absorbing walls 362 are located in the transparent layer 340 and extend from the back surface 340b of the transparent layer 340 to the front surface 340a of the transparent layer 340. Moreover, the light absorbing walls 362 are substantially aligned to an edge of the bottom surface of the lens structures 380 to divide the transparent layer 340 into a plurality of areas B corresponding to the lens structures 380 and the light-mixing chambers 370 respectively.

As FIG. 2 shows, the lens structure is adapted to refract the inclined light beam R4 from the projection device 400, and the opening of the corresponding light-mixing chamber 370 is adapted to allow the light beam R4 pass through, such that the corresponding light-mixing chamber is adapted to concentrate the light beam R4 therein and transform the light beam R4 into a light beam R5 projected out of the screen 300. The angular distribution of the light beam R5 is symmetrically distributed relative to the central line N1 of the opening of the light-mixing chamber 370. On the other hand, environment light beam R6 with large incident angle would be refracted to the light absorbing layer 360 or the light absorbing wall 362 surrounding the opening of the light-mixing chamber 370 by the lens structures 380. Thus, the screen 300 in the present embodiment not only improves symmetry of the images, prevents glare light, but also avoids image contrast from being influenced by environment light beam.

As FIG. 2 shows, the light-mixing chamber 370 in the present embodiment is roughly located at the focus of the lens structure 380 and on the optical axis A1 of the lens structures 380. In order to transform the inclined light beam R4 from the projection device 400 into the light beam R5 distributed symmetrically to the central line N1 of the opening of the light-mixing chamber 370, the shape of the light-mixing chamber 370 is symmetrical to the center line N1 of the opening of the light-mixing chamber as a embodiment. Furthermore, in the present embodiment, the projection device 400 is disposed at a higher position. The light beam R4 from the projection device 400 is obliquely downwards projected to the screen 300. Under such circumstance, in order to make audience at different observation positions able to access image with similar contrast, as a embodiment, the light-mixing chamber 370 is longitudinal symmetrical to a horizontal plane and the central line N1 of the opening of the light-mixing chamber 370 is parallel to the horizontal plane to make the light beam R5 evenly distributed above and below the horizontal plane.

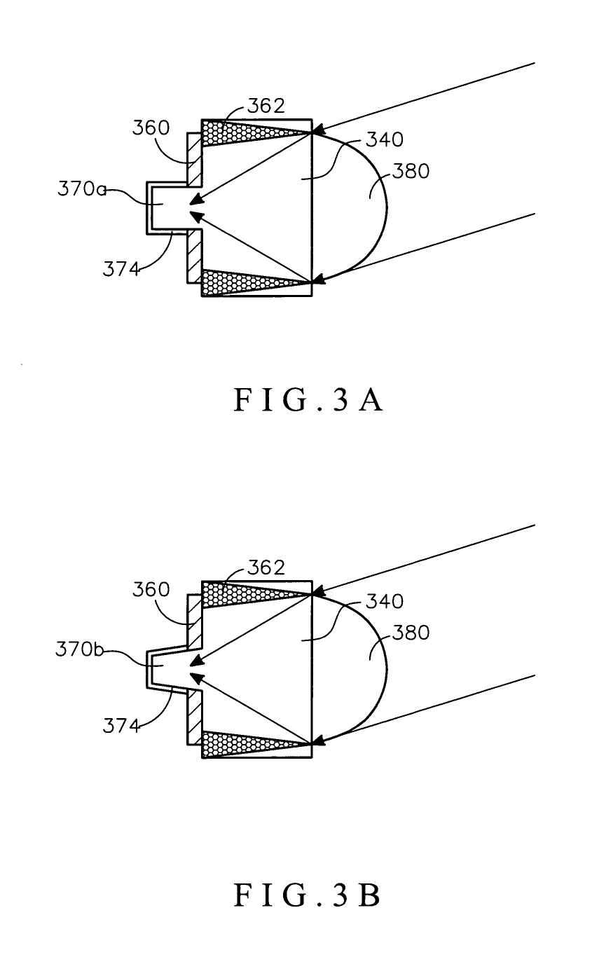

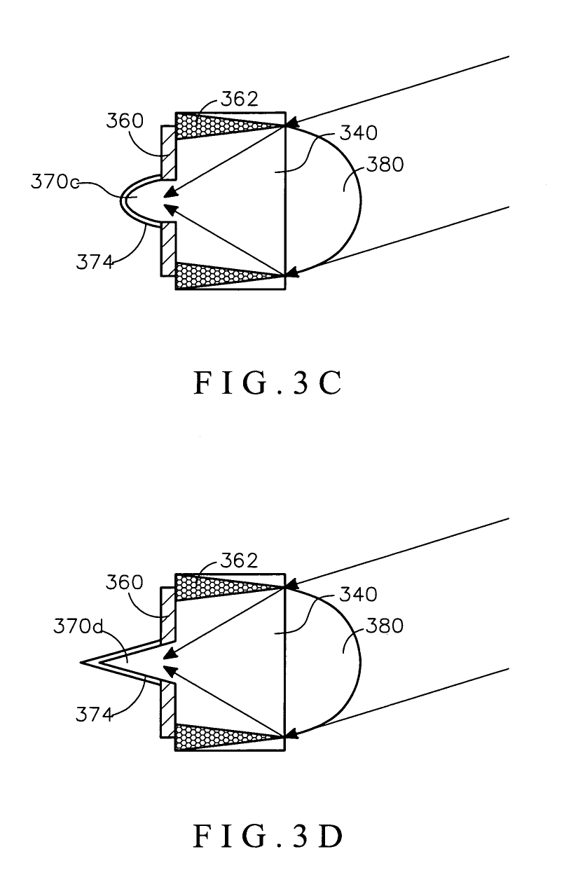

As FIG. 2 shows, in the present embodiment, the cross sections of the light-mixing chamber 370 along the vertical direction V and the normal direction of the screen 300 are rectangular in shape. However, the shape of the light-mixing chamber 370 in the present invention is not limited. The light-mixing chamber 370 in the present embodiment may adopt different designs to achieve the object of the present invention. For example, as FIG. 3A to FIG. 3D show, the cross sections of the light-mixing chambers 370a, 370b, 370c, and 370d along the vertical direction V and the normal direction of the screen 300 in the present invention may be square, taper-shaped, arc-shaped, or triangular to generate the evenly distributed the light beam R5 relative to the central line N1 of the light-mixing chamber 370.

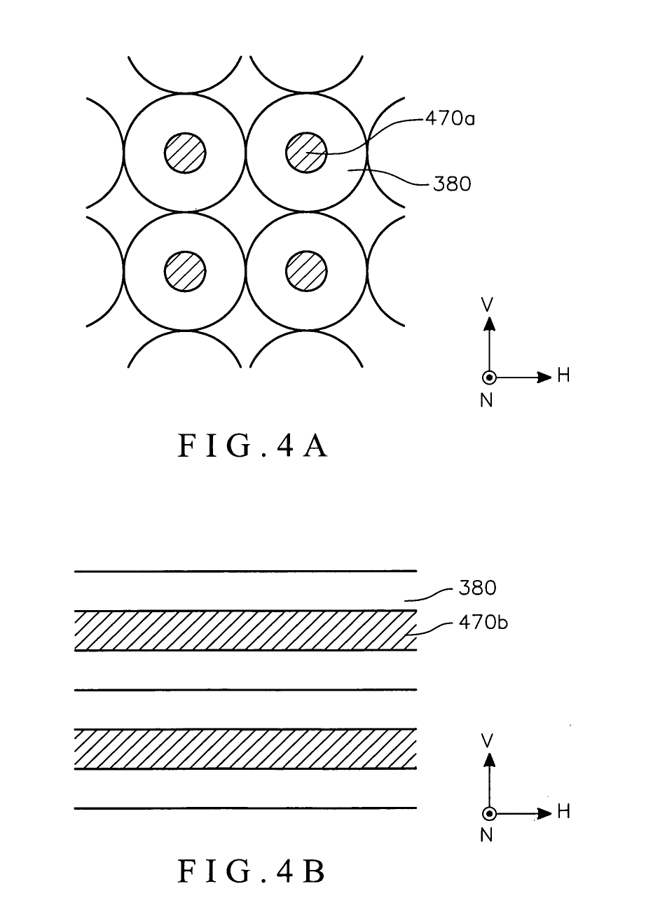

Subsequently, FIG. 4A and FIG. 4B are schematic views showing two different embodiments of the configurations of the light-mixing chamber, in which the front surface of the screen is shown. Referring to FIG. 2, FIG. 4A and FIG. 4B, the light-mixing chamber 370 of the embodiment of the present invention may be a concave 470a perpendicular to the back surface 340b of the transparent layer 340, or a groove 470b traversing the back surface 340b of the transparent layer 340. Furthermore, as the groove 470b shown in FIG. 4B is used as the light-mixing chamber 370, the groove 470b extends along the horizontal direction H of the screen 300. However, the present invention is not limited to this. In an embodiment, the groove 470b may extend along a certain inclined direction if needed.

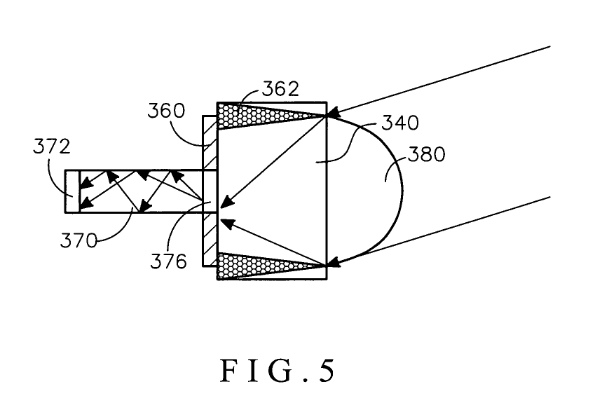

In the embodiment of FIG. 2, the bottom surface of the light-mixing chamber 370 is covered with a light scattering layer 372 to improve uniformity of the light beam R5. However, the present invention is not limited to this. In the embodiment of FIG. 3A to FIG. 3D, the light scattering layer 374 covers all inner walls of the light-mixing chambers 370a, 370b, 370c, and 370d, including the bottom and the side surfaces. Furthermore, as FIG. 5 shows, in another embodiment of the present invention, a light diffusion layer 376 is used to cover the opening of the light-mixing chamber 370 to randomly diffuse the light beam R5 from the light-mixing chamber 370 so as to provide a greater viewing angle for audience. Moreover, the transparent material filled in the light-mixing chamber 370 may be mixed with light diffusion material, such as light diffusion particles (as FIG. 2 shows). These ways are helpful for improving light uniformity.

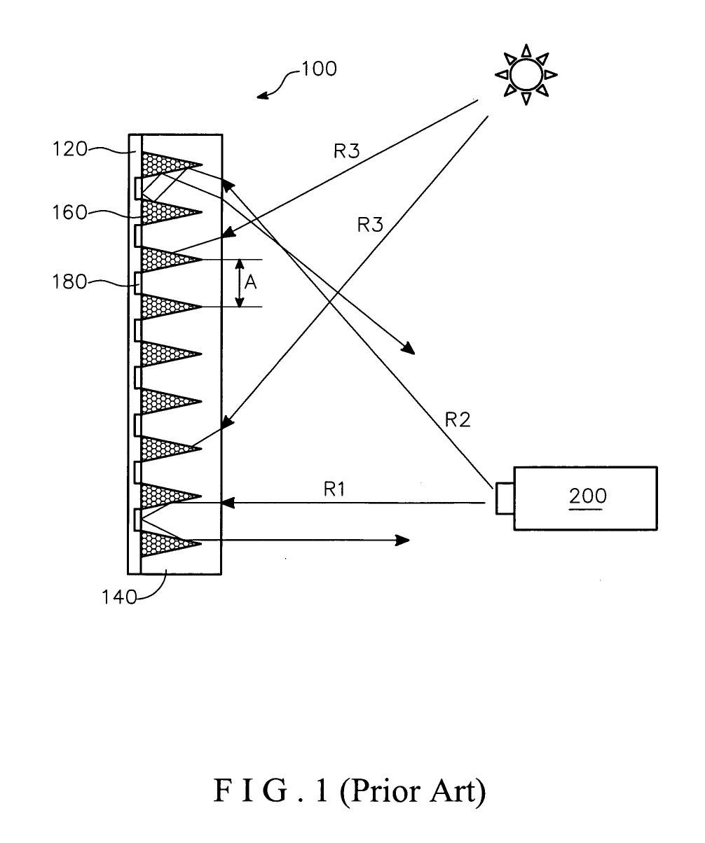

The distribution of viewing area of the conventional screen 100 in FIG. 1 is not symmetrical to the center of the screen 100, which causes image contrast at different observation positions showing significant difference. In comparison, referring to FIG. 2, in the screen 300 of the present embodiment, the light-mixing chambers 370 are disposed on the back surface 340b of the transparent layer 340 away from the projection device 400 and the lens structures 380 are disposed on the front surface 340a of the transparent layer 340 facing towards the projection device 400. The lens structures 380 are used to collect the inclined light beam R4 from the projection device 400 into the light-mixing chamber 370 so as to transform the inclined light beam R4 into the light beam R5 with angular distribution symmetrical to the central line N1 of the opening of the light-mixing chamber 370. The central line N1 is parallel to the normal direction N of the screen 300. Thus, the screen 300 in the present embodiment may improve the distribution of the image light reflected from the screen so as to have images at different observation positions consistent to enlarge the viewing angle. Moreover, as FIG. 2 shows, the screen 300 in the present embodiment has the light absorbing layer 360 covering the back surface 340b of the transparent layer 340 and has a plurality of light absorbing walls 362 extending from the back surface 340b of the transparent layer 340 to the front surface 340a of the transparent layer 340. The light absorbing layer 360 and the light absorbing walls 362 may absorb the environment light beam R6 with large incident angle to prevent the generation of glare light and avoid the image contrast from being influenced by the environment light beam R6.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A screen, adapted to a projection device, comprising:
a transparent layer;
a plurality of light-mixing chambers, disposed on a back surface of the transparent layer away from the projection device; and
a plurality of lens structures, disposed on a front surface of the transparent layer facing towards the projection device, and corresponding to the light-mixing chambers respectively,
wherein the size of an opening of each of the light-mixing chambers is smaller than the size of a bottom surface of each of the corresponding lens structures connecting the front surface of the transparent layer, each of the lens structures is adapted to refract a light beam from the projection device, and the opening of each of the corresponding light-mixing chambers is adapt to allow the light beam pass through, such that each of the corresponding light-mixing chambers is adapted to concentrate the light beam therein and transform the light beam into a light beam projected out of the screen.

2. The screen of claim 1, further comprising a light absorbing layer covering the back surface of the transparent layer and surrounding the openings of the light-mixing chambers.

3. The screen of claim 1, further comprising at least one light absorbing wall, located in the transparent layer and extending from the back surface of the transparent layer to the front surface of the transparent layer, and aligned to an edge of the bottom surface of each of the corresponding lens structures.

4. The screen of claim 1, wherein a shape of the light-mixing chambers is symmetrical to a central line of the opening of each of the corresponding light-mixing chambers.

5. The screen of claim 1, wherein a cross section of each of the light-mixing chambers along a vertical direction of the screen and a normal direction of the screen is square, rectangular, taper-shaped, arc-shaped, or triangular.

6. The screen of claim 1, wherein the shape of each of the light-mixing chambers is symmetrical to a plane perpendicular to a vertical direction of the screen, and the plane overlaps a central line of the opening of each of the corresponding light-mixing chambers.

7. The screen of claim 1, wherein the bottom surface of each of the light-mixing chambers is covered with a light scattering layer covers a bottom of the light-mixing chamber.

8. The screen of claim 1, wherein the opening of each of the light-mixing chambers is covered with a light diffusion layer.

9. The screen of claim 1, wherein each of the light-mixing chambers is filled with a transparent material mixed with a light scattering material.

10. The screen of claim 1, wherein an inner wall of each of the light-mixing chambers is covered with a light scattering layer.

11. The screen of claim 1, wherein focuses of the lens structures are substantially located in the light-mixing chambers respectively.
